(19) United States
(12) Patent Application Publication
(10) Pub. No.: US 2023/0335015 A1
(43) Pub. Date: Oct. 19, 2023

(54) EXPERIMENTAL APPARATUS FOR SIMULATING SUBSTANCE EXCHANGE BETWEEN WELLBORE AND FORMATION

(71) Applicants: CHINA UNITED COALABED METHANE ENGINEERING RESEARCH CENTER CO., LTD., Beijing (CN); CHINA UNIVERSITY OF PETROLEUM ( BEIJING), Beijing (CN)

(72) Inventors: Junyao Deng, Beijing (CN); Fengyin Xu, Beijing (CN); Jinhui Zhou, Beijing (CN); Lei Zhang, Beijing (CN); Dong Chen, Beijing (CN); Yuan Wang, Beijing (CN); Yuan Ji, Beijing (CN); Xiaoyi Sun, Beijing (CN); Liwei Chi, Beijing (CN); Yi Zhang, Beijing (CN); Siqi Mo, Beijing (CN); Yun Yang, Beijing (CN)

(21) Appl. No.: 18/023,196

(22) PCT Filed: Mar. 25, 2022
(86) PCT No.: PCT/CN2022/083177

§ 371 Date: Feb. 24, 2023

(30) Foreign Application Priority Data
Mar. 26, 2021 (CN) 202110327751.4

(51) Int. Cl. E21B 41/00; G09B 25/02

(52) U.S. Cl. CPC G09B 25/02; E21B 41/00

(57) ABSTRACT

An experimental apparatus for simulating substance exchange between a wellbore and a formation. The apparatus includes: a wellbore simulation system, a wellbore liquid injection system, a formation simulation system, a formation fluid injection system, and a data acquisition system; the wellbore simulation system includes a vertically arranged wellbore body for simulating a wellbore; the formation simulation system includes a horizontally arranged sealing body for simulating a formation and a mortar filler filled in the sealing body; the wellbore liquid injection system is connected to the upper end of the wellbore body; the formation fluid injection system is connected to one end of the sealing body so as to inject a formation fluid into the sealing body; the other end of the sealing body is communicated with the bottom of the wellbore body; and the data acquisition system is electrically connected to the wellbore simulation system and the formation simulation system.

### CROSS-REFERENCE TO RELATED APPLICATIONS

The present application is a U.S. National Phase Entry of International Application PCT/CN2022/083177 having an international filing date of Mar. 25, 2022, which claims priority of Chinese patent application No. 202110327751.4, filed on Mar. 26, 2021 and entitled “Experimental Apparatus for Simulating Substance Exchange Between Wellbore and Formation”. The entire contents of the above-identified application are hereby incorporated by reference.

### TECHNICAL FIELD

The application relates to but is not limited to the technical field of oil and gas exploitation, in particular to but is not limited to an experimental apparatus for simulating substance exchange between a wellbore and a formation.

### BACKGROUND

During well drilling of oil and gas resources, a difference ΔP between a liquid column pressure Pₕ generated by an operating liquid in a wellbore and a fluid pressure Pₚ in formation pores is defined as a pressure difference. Controlling the pressure difference is a key for drilling safety and reservoir protection. Under the action of the pressure difference, relative flow between the operating liquid in the wellbore and the fluid in formation pores will occur. When ΔP = 0, it is a balanced drilling mode, and the operating liquid in the wellbore cannot enter the formation, nor can the fluid in the formation enter the wellbore. When ΔP > 0, it is an over-balanced drilling mode, and the operating liquid in the wellbore enters the formation, and the reservoir near the wellbore will be polluted by the operating liquid, resulting in that a production capacity cannot meet expectations. In severe cases, it will lead to a large loss of the operating liquid in the wellbore, causing huge financial losses. When ΔP < 0, it is an under-balanced drilling mode, and the formation fluid enters the wellbore to form well intrusion, which, if not controlled, will cause vicious accidents such as well kick and even blowout. In the drilling processes of some oil and gas reservoirs with low permeability, low pressure, and low abundance, the under-balanced drilling mode is intentionally adopted to allow the formation fluid to enter the wellbore, so as to achieve a purpose of discovering oil and gas reservoirs as early as possible and protecting the reservoirs. Moreover, formations with different physical parameters have different forms of fluid exchange under the action of pressure difference, exchange capacity and exchange rate need to be studied and determined, and a drilling hydraulic pressure difference needs to be reasonably determined while giving consideration to drilling safety and reservoir protection.

### SUMMARY

The following is a summary of the subject matter described in detail herein. This summary is not intended to limit the protection scope of the claims.

An experimental apparatus for simulating substance exchange between a wellbore and a formation includes a wellbore simulation system, a wellbore liquid injection system, a formation simulation system, a formation fluid injection system and a data acquisition system;
the wellbore simulation system includes a vertically arranged wellbore body for simulating the wellbore;
the formation simulation system includes a horizontally arranged sealing body for simulating the formation, and a mortar filler filled in the sealing body;
the wellbore liquid injection system is connected to an upper end of the wellbore body and configured to inject a wellbore liquid into the wellbore body; the formation fluid injection system is connected to one end of the sealing body and configured to inject a formation fluid into the sealing body; the other end of the sealing body is communicated to a bottom end of the wellbore body; the data acquisition system is electrically connected to the wellbore simulation system and the formation simulation system so as to acquire simulation data.

Other aspects will become apparent after reading and understanding the drawings and detailed description.

### BRIEF DESCRIPTION OF DRAWINGS

Accompanying drawings are used to provide a further understanding of the technical solution herein, and constitute a part of the specification. They are used together with the embodiments of the present application to explain the technical solution herein, and do not constitute a restriction on the technical solution herein.

FIG. 1 is a schematic diagram of a connection structure of an experimental apparatus for simulating substance exchange between a wellbore and a formation in an embodiment of the present application.

In the figure: 1. data acquisition system; 2. wellbore body; 3. sealing body; 4. liquid tank; 5. first booster pump; 6. first valve; 7. second booster pump; 8. second valve; 9. third valve; 10. first pressure measuring unit; 11. second pressure measuring unit; 12. third pressure measuring unit; 13. discharge valve; 14. oil source; 15. gas source; 16. water source; 17. mixing valve; 18. fourth valve.

### DETAILED DESCRIPTION

Hereinafter, embodiments of the present application will be described with reference to the accompanying drawings. It should be noted that, the embodiments in the present application and the features in the embodiments may be combined with each other randomly if there is no conflict.

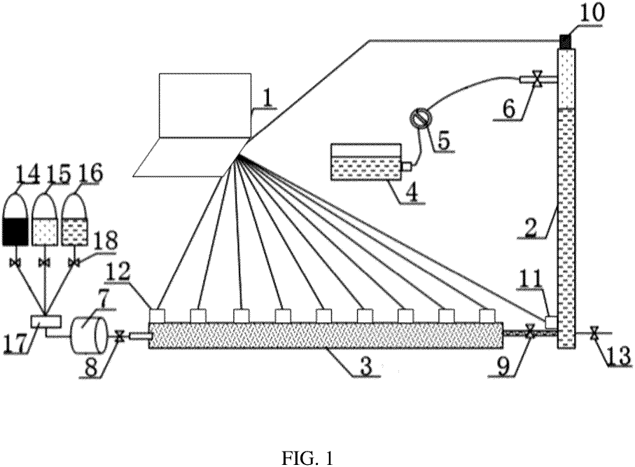

An embodiment of the present application discloses an experimental apparatus for simulating substance exchange between a wellbore and a formation, as shown in FIG. 1. The experimental apparatus includes a wellbore simulation system, a wellbore liquid injection system, a formation simulation system, a formation fluid injection system and a data acquisition system 1.

The wellbore simulation system includes a vertically arranged wellbore body 2 for simulating a wellbore.

The formation simulation system includes a horizontally arranged sealing body 3 for simulating a formation, and a mortar filler filled in the sealing body 3. The mortar filler is formed after mixing cement and sand with different proportions, stirring the mixture and a proper amount of clear water and then solidifying. According to the needs of simulating formation with different permeability and porosities, the proportions of cement and sand may be varied and adjusted to reach physical parameters of the actual formation. For example, when a high permeability formation needs to be simulated, the proportion of sand should be increased.

The wellbore liquid injection system is connected to an upper end of the wellbore body 2 and configured to inject a wellbore liquid into the wellbore body 2. The formation fluid injection system is connected to one end of the sealing body 3 and configured to inject a formation fluid into the sealing body 3 to simulate a distal end of the formation. The other end of the sealing body 3 is communicated to a bottom end of the wellbore body 2. The data acquisition system 1 is electrically connected to the wellbore simulation system and the formation simulation system (i.e. both the wellbore simulation system and the formation simulation system are electrically connected to the data acquisition system 1) so as to acquire simulation data.

In the experimental apparatus of the present embodiment, the vertical wellbore body for simulating the wellbore and the horizontal sealing body for simulating the formation are arranged, so that a regularity of the fluid flow between the wellbore and the formation under different pressure differences can be simulated. By varying the mortar filler in the sealing body, fluid exchange forms of formations with different physical properties under the action of pressure difference can also be simulated.

It should be understood that the wellbore body 2 may be arranged vertically to simulate a vertical wellbore; or, the wellbore body 2 may be arranged horizontally or arranged obliquely to simulate a horizontal wellbore or an inclined wellbore.

In one embodiment, as shown in FIG. 1, the wellbore liquid injection system includes a liquid tank 4, a first booster pump 5, and a first valve 6.

The liquid tank 4, the first booster pump 5 and the first valve 6 are sequentially connected to the upper end of the wellbore body 2, and a pressure in the wellbore body 2 can be adjusted by the first booster pump 5, thus simulating the pressure in a real wellbore. The liquid tank 4 is filled with wellbore liquid, and the first booster pump 5 can inject a preset amount of wellbore liquid into the wellbore body 2 according to experimental requirements, so that the wellbore liquid in the wellbore body 2 generates a preset liquid column pressure, which is used to simulate the operating liquid in the wellbore.

In one embodiment, as shown in FIG. 1, the formation fluid injection system includes a fluid source, a second booster pump 7, and a second valve 8.

The fluid source, the second booster pump 7 and the second valve 8 are sequentially connected to one end of the sealing body 3, and a pressure in the sealing body 3 can be adjusted by the second booster pump 7, thus simulating a pressure of a real formation. The fluid source includes an oil source 14, a gas source 15 and a water source 16, which are mixed to form a formation fluid, and then connected to the second booster pump 7 through a mixing valve 17. Fourth valves 18 are separately arranged at the outlets of the oil source 14, the gas source 15 and the water source 16 to control a mixing ratio of the oil, gas and water, thus simulating fluids with different properties.

The mixing valve 17 has four ports, including three inlets and one outlet. The oil source 14, the gas source 15 and the water source 16 are connected to the second booster pump 7 through the mixing valve 17, i.e. the outlets of the oil source 14, the gas source 15 and the water source 16 are respectively connected to the three inlets of the mixing valve 17, and the outlet of the mixing valve 17 is connected to the inlet of the second booster pump 7.

The fourth valves 18 may be flow valves to control the amounts of oil, gas and water flowing out of the oil source 14, the gas source 15 and the water source 16, thus controlling the mixing ratio of the oil, gas and water. It should be understood that the fourth valves 18 may be arranged at the outlets of all of the oil source 14, the gas source 15, and the water source 16, or the fourth valves 18 may be arranged only at the outlets of any two of the oil source 14, the gas source 15, and the water source 16.

In one embodiment, the first booster pump 5 and the second booster pump 7 are constant pressure pumps (the constant pressure pump here should be understood to perform pressurization with a constant pressure in an experimental state, but the pressures at the formation and the wellbore in actual drilling are not at idealized constant values, so the two booster pumps can be set to have a large and adjustable pressure range), to ensure that the first booster pump 5 and the second booster pump 7 inject a wellbore liquid and a formation fluid under constant pressure, so that the pressure difference between the bottom end of the wellbore body 2 and the formation fluid injection end of the sealing body 3 is always kept at a constant value.

In one embodiment, the first valve 6 and the second valve 8 are set as one-way valves to prevent the wellbore liquid in the wellbore body 2 from reversely flowing to the first booster pump 5 and prevent a formation fluid in the sealing body 3 from reversely flowing to the second booster pump 7.

In one embodiment, as shown in FIG. 1, a third valve 9 is arranged between the wellbore body 2 and the sealing body 3, and the third valve 9 is arranged on a connecting line between the wellbore body 2 and the sealing body 3 for controlling on-off between the wellbore body 2 and the sealing body 3.

In one embodiment, as shown in FIG. 1, a first pressure measuring unit 10 is arranged at the upper end of the wellbore body 2, and a second pressure measuring unit 11 is arranged at the bottom end of the wellbore body 2 to respectively monitor pressures at the upper end and the bottom end of the wellbore body 2. Several third pressure measuring units 12 are evenly arranged on the sealing body 3 and configured for monitoring pressures at different positions of the sealing body 3. For example, several mounting interfaces for the pressure measuring units may be provided on the sealing body 3 as required, and the formation fluid in the sealing body 3 can flow to the interfaces and transmit the fluid pressure there to the third pressure measuring units 12. The wellbore simulation system includes the first pressure measuring unit 10 and the second pressure measuring unit 11 described above, and the formation simulation system includes the third pressure measuring units 12 described above. The pressure measuring units (including the first pressure measuring unit 10, the second pressure measuring unit 11 and the third pressure measuring units 12) are all electrically connected to the data acquisition system 1, and the data acquisition system 1 can analyze a state of the fluid flow between the wellbore body 2 and the sealing body 3 according to the real-time monitored pressures, and then analyze a state of the fluid flow between the wellbore and the formation.

In one embodiment, the pressure measuring units are pressure sensors or pressure gauges. That is, the first pressure measuring unit 10, the second pressure measuring unit 11 and/or the third pressure measuring units 12 may be pressure sensors or pressure gauges.

In one embodiment, a drain pipe is arranged at the bottom end of the wellbore body 2, and a discharge valve 13 is arranged on the drain pipe and configured for controlling a height of the liquid column in the wellbore body 2, thus adjusting the pressure at the bottom end of the wellbore body 2.

In one embodiment, the wellbore body 2 is a transparent wellbore body. For example, the wellbore body 2 may include several transparent glass tubes, through which a flow state of gas-liquid two-phase fluid in the wellbore body 2 can be directly observed, and the visualization effect is good. Two adjacent transparent glass tubes are connected and fixed together by a plurality of bolt sets, and are provided with a sealing ring to improve sealing performance. In addition, the transparent glass tube has certain pressure resistance, and can withstand the pressure generated by the wellbore liquid in a simulation test.

A cross section of the wellbore body 2 may be round, elliptical, square, rectangular or rhombic. Of course the cross section of the wellbore body 2 is not limited to the above-mentioned shapes and the specific shape may be adjusted as required.

For the convenience of observing the height of the wellbore liquid in the wellbore body 2 and calculating a changing value of the height of the wellbore liquid during the simulation test, the wellbore body 2 is marked with a scale line. Or, a liquid level sensor may be arranged on the wellbore body 2 to detect a liquid level of the wellbore liquid, thus the changing value of the height of the wellbore liquid can be obtained.

Use steps of the experimental apparatus for simulating substance exchange between a wellbore and a formation in an embodiment of the present application are as follows:

Step 1: The mortar filler in the sealing body 3 is produced. According to physical parameters of a simulated formation, cement and sand are mixed according to a certain ratio, and clear water is added and stirred evenly to make a mixture. The mixture is poured into the sealing body 3 and tamped. After the mixture solidifies, the sealing body 3 is connected to other components to form the experimental apparatus.

Step 2: All valves are closed, and then the fourth valves 18 at the outlets of the oil source 14, the gas source 15 and the water source 16 are adjusted according to properties of fluid in the simulated formation (i.e. adjust the opening of the fourth valves 18).

Step 3: The first valve 6, the second valve 8 and the mixing valve 17 are opened (or, the first valve 6 and the second valve 8 are opened, and the mixing valve 17 is always in communication), and the first booster pump 5 and the second booster pump 7 are started to inject the wellbore liquid into the wellbore body 2 and to inject the formation fluid into the sealing body 3. The first booster pump 5 and the first valve 6 are closed when the pressure monitored by the second pressure measuring unit 11 reaches a first preset pressure, and the second booster pump 7 and the second valve 8 are closed when all the pressures monitored by the third pressure measuring units 12 reach the second preset pressure. The first preset pressure is a liquid column pressure generated by the operating liquid in the simulated wellbore, the second preset pressure is a fluid pressure in the simulated formation pores, and a difference between the first preset pressure and the second preset pressure is ΔP.

Step 4: The first valve 6, the second valve 8 and the third valve 9 are opened, and the first booster pump 5 and the second booster pump 7 are started, the fluid in the wellbore body 2 and the fluid in the sealing body 3 undergo substance exchange under the action of the pressure difference ΔP. When ΔP > 0, the wellbore liquid in the wellbore body 2 will enter the sealing body 3 and be mixed with the formation fluid; when ΔP < 0, the formation fluid in the sealing body 3 will enter the wellbore body 2 and be mixed with the wellbore liquid.

Step 5: The values of the pressure measuring units (including the first pressure measuring unit 10, the second pressure measuring unit 11 and the third pressure measuring units 12) are observed, and a volume change of the gas-liquid two-phase fluid in the wellbore body 2 is observed and recorded. When the pressure values monitored by the second pressure measuring unit 11 and all the third pressure measuring units 12 are consistent, the first booster pump 5 and the second booster pump 7 are shut down, and data acquisition is stopped.

Step 6: The data acquisition system 1 performs analysis according to the monitored pressure data.

When ΔP > 0, the amount of a wellbore liquid intruding into the sealing body 3 can be calculated.

When ΔP < 0, the amount of a formation fluid intruding into the wellbore body 2 can be calculated, and properties of the intruding fluid in the wellbore body 2 can also be analyzed. Based on a change in a volume of the gas phase fluid in the wellbore body 2 and a change in the pressure monitored by the first pressure measuring unit 10, it is possible to determine whether there is gas in the intruding fluid and to calculate the amount of the gas. Based on a change in the volume of the liquid phase fluid in the wellbore body 2 and a change in the pressure monitored by the second pressure measuring unit 11, it is possible to determine whether there is oil in the intruding fluid and to calculate the amount of the oil.

In the description of the present application, it should be noted that orientation or position relationships indicated by the terms “upper end”, “bottom end”, “one end”, “the other end”, “vertical” and “horizontal” and the like are based on the orientation or position relationships shown in the drawings, which are only for convenience of describing the present application and simplifying the description, rather than indicating or implying that the structure referred has the specific orientation, or is constructed and operated in the specific orientation, and thus cannot be interpreted as a limitation on the present application.

In the description of the present application, it should be noted that the term “several” refers to one, two or more.

In the description of the present application, unless otherwise explicitly specified and limited, terms “connection”, “fixation” and the like should be understood in a broad sense. For example, “connection” may be a fixed connection, a detachable connection or an integrated connection; and may be a direct connection, or an indirect connection through an intermediary, or an internal communication between two elements. For those of ordinary skills in the art, specific meanings of the above terms in the present application can be understood according to specific situations.

Although implementations disclosed herein are described above, the described contents are only implementations used for facilitating understanding of the present application, and are not intended to limit the present application. Without departing from the spirit and scope disclosed herein, any person skilled in the art to which the present application pertains may make any modifications and changes in the form and details of implementation, but the scope of patent protection of the present application shall still be defined by the appended claims.

What we claim is:

1. An experimental apparatus for simulating substance exchange between a wellbore and a formation, wherein the experimental apparatus comprises a wellbore simulation system, a wellbore liquid injection system, a formation simulation system, a formation fluid injection system and a data acquisition system;
the wellbore simulation system comprises a vertically arranged wellbore body for simulating the wellbore;
the formation simulation system comprises a horizontally arranged sealing body for simulating the formation, and a mortar filler filled in the sealing body;
the wellbore liquid injection system is connected to an upper end of the wellbore body and configured to inject a wellbore liquid into the wellbore body; the formation fluid injection system is connected to one end of the sealing body and configured to inject a formation fluid into the sealing body; the other end of the sealing body is communicated to a bottom end of the wellbore body; the data acquisition system is electrically connected to the wellbore simulation system and the formation simulation system so as to acquire simulation data.

2. The experimental apparatus according to claim 1, wherein the wellbore liquid injection system comprises: a liquid tank, a first booster pump, and a first valve;
the liquid tank, the first booster pump and the first valve are sequentially connected to the upper end of the wellbore body.

3. The experimental apparatus according to claim 2, wherein the formation fluid injection system comprises: a fluid source, a second booster pump, and a second valve;
the fluid source, the second booster pump and the second valve are sequentially connected to one end of the sealing body.

4. The experimental apparatus according to claim 3, wherein the fluid source comprises an oil source, a gas source and a water source; the oil source, the gas source and the water source are all connected to inlets of a mixing valve, and an outlet of the mixing valve is connected to the second booster pump.

5. The experimental apparatus according to claim 4, wherein fourth valves are each provided at outlets of the oil source, the gas source and the water source to control a mixing ratio of oil, gas and water.

6. The experimental apparatus according to claim 3, wherein the first booster pump and the second booster pump are constant pressure pumps.

7. The experimental apparatus according to claim 3, wherein the first valve and the second valve are one-way valves.

8. The experimental apparatus according to claim 1, wherein a third valve is arranged between the wellbore body and the sealing body.

9. The experimental apparatus according to claim 1, wherein the wellbore simulation system further comprises a first pressure measuring unit arranged at the upper end of the wellbore body, and a second pressure measuring unit arranged at the bottom end of the wellbore body; the formation simulation system further comprises a plurality of third pressure measuring units evenly arranged on the sealing body, and the first pressure measuring unit, the second pressure measuring unit and the third pressure measuring units are all electrically connected to the data acquisition system.

10. The experimental apparatus according to claim 9, wherein the first pressure measuring unit, the second pressure measuring unit and/or the third pressure measuring units are pressure sensors or pressure gauges.

11. The experimental apparatus according to claim 1, wherein a drain pipe is arranged at the bottom end of the wellbore body, and the drain pipe is provided with a discharge valve.

12. The experimental apparatus according to claim 1, wherein the wellbore body comprises a plurality of transparent glass tubes;
the wellbore body is marked with a scale line.
